(19) United States
(12) Patent Application Publication
(10) Pub. No.: US 2019/0246612 A1
(43) Pub. Date: Aug. 15, 2019

(54) Fishing Lure With Magnetic Action

(71) Applicant: Aaron Jacob Shunk, Houston, TX (US)

(72) Inventor: Aaron Jacob SHUNK, Houston, TX (US)

(21) Appl. No.: 15/894,817

(22) Filed: Feb. 12, 2018

(51) Int. Cl. A01K 85/18

(52) U.S. Cl. CPC A01K 85/18; A01K 83/00

(57) ABSTRACT

A fishing lure comprising: i) a body segment; ii) a tail segment; iii) a linkage for coupling the body segment and the tail segment; iv) a first magnet coupled to the body segment; and v) a second magnet coupled to the tail segment. The first and second magnets are set up in a state of repulsion in order to move the body segment and tail segment apart. The linkage is adjustable in length in order to increase or decrease the force of repulsion between the first and second magnets.

### TECHNICAL FIELD

The present application relates generally to fishing lures and, more specifically, to a fishing lure having multiple body segments that are articulated by magnetic repulsion.

### BACKGROUND

Fishing lures are sold in many different types, sizes, and shapes. Designers have gone to great lengths to make fishing lures appear as realistic as possible. Many fishing lures are molded and painted to resemble particular types of bait fish and shiny objects or surfaces are frequently attached in order to attract the targeted fish. However, it would be even more desirable if a fishing lure was capable of simulating the movement of a live or injured bait fish.

### SUMMARY

To address the above-discussed deficiencies of the prior art, it is a primary object to provide a fishing lure comprising: i) a body segment; ii) a tail segment; iii) a linkage for coupling the body segment and the tail segment; iv) a first magnet coupled to the body segment; and v) a second magnet coupled to the tail segment. The first and second magnets are set up in a state of repulsion in order to force the body segment and tail segment apart.

In one embodiment, the linkage connecting repelling segments is adjustable in length in order to increase or decrease the force of repulsion between the first and second magnets.

In another embodiment, the linkage between segments is coupled at a fixed distance between the first and second magnets.

In still another embodiment, the linkage comprises a first portion attached to a face of the first magnet and a second portion that is interlocked with the first portion and is attached to a face of the second magnet.

In yet another embodiment, the first portion comprises a first loop and the second portion comprises a second loop interlocked with the first loop.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary fishing lure according to an embodiment of the present disclosure.

FIG. 2 illustrates two exemplary magnets positioned to repel each other.

FIGS. 3A and 3B illustrate in greater detail a configuration for the adjustable length linkage in an exemplary fishing lure according to an embodiment of the present disclosure.

FIG. 4 illustrates articulated motion of the lure used to generate electrical energy in an exemplary fishing lure according to an embodiment of the present disclosure.

### DETAILED DESCRIPTION

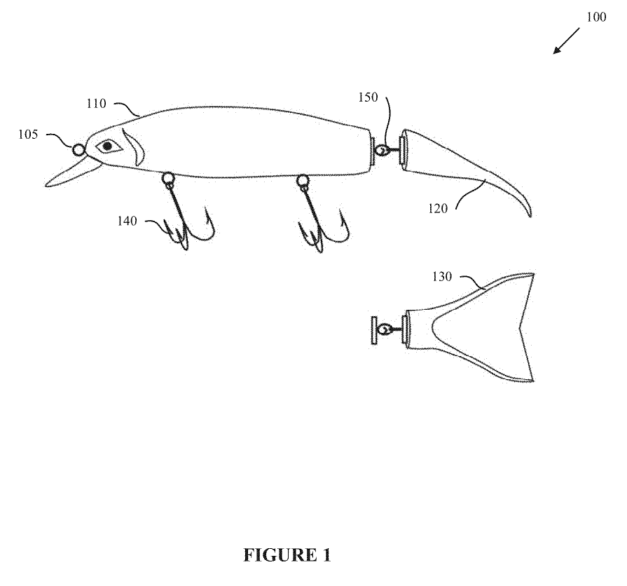

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged fishing lure.

The present disclosure describes a segmented or jointed fishing lure that uses magnets in a state of repulsion to create an oscillatory motion that gives the appearance that the fishing lure is moving its body, particularly its tail fin, and swimming. As the fishing lure is pulled through water, is buffeted by moving water, or is dragged on the bottom, the segments of the fishing lure body will be articulated with respect to each other at the linkage(s) that join the segments. The repulsion of the magnets attached to each body segment causes the body to snap back into a straightened position, which gives the illusion of swimming, or other movements. The option for adjustable length of the linkage moves the magnets closer together or farther apart, thereby increasing or decreasing the force of repulsion. The configuration of repelling magnets may also be used with auxiliary segments to the main lure body and head segment, such as fins, legs, mouthparts, or hooks. The linkage configuration and design between repelling segments can vary in design and material.

FIG. 1 illustrates exemplary fishing lure 100 according to an embodiment of the present disclosure from a left lateral perspective. Fishing lure 100 comprises eyelet 105, body segment 110, tail segment 120, one or more hook(s) 140, and linkage 150. An alternative tail segment 130 is also shown. A fishing line (not shown) may be threaded through eyelet 105 and knotted to attach fishing lure 100 to the fishing line.

In the exemplary embodiment, fishing lure 100 comprises only two segments: body segment 110 and tail segment 120. Also, only one linkage 150 is shown coupling the two segments. However, this is by way of illustration only and should not be construed to limit the scope of this disclosure. In alternate embodiments, fishing lure 100 may comprise three or more segments and any segment may be coupled to another segment using two or more magnetic linkages 150.

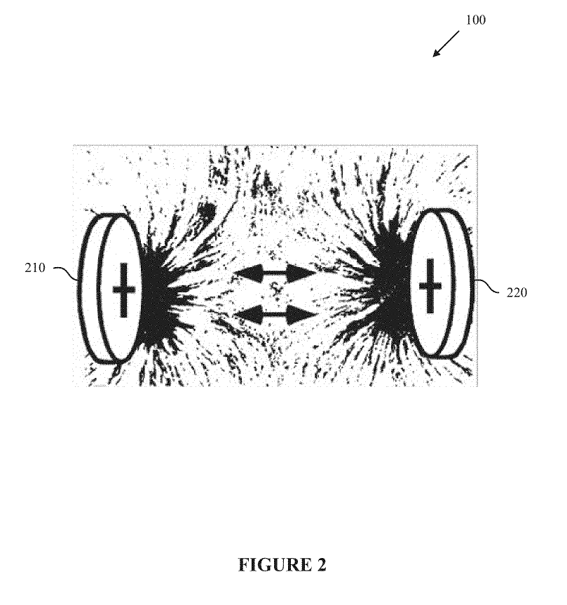

FIG. 2 illustrates two exemplary magnets 210 and 220 positioned to repel each other. All magnets have a north-seeking (or positive) pole, typically labeled “N” or “+”, and a south-seeking (or negative) pole, typically labeled “S” or “−”. Opposite poles attract and similar poles repel. In FIG. 2, the north-seeking or positive pole of magnetic 210 is facing towards the north-seeking or positive pole of magnetic 220. This creates a repulsive force that is represented by the double arrow headed lines between magnets 210 and 220. The other curved lines represent the magnetic field lines of each of magnets 210 and 220. If magnet 210 is mounted on body segment 110 and magnet 220 is mounted on tail segment 120, such that magnets 210 and 220 are in close proximity to linkage 150, then magnets 210 and 220 will repel and push body segment 110 and tail segment 120 apart.

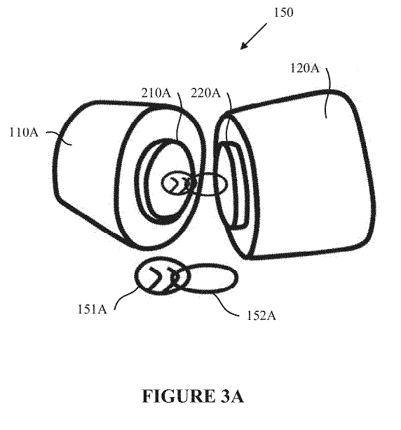

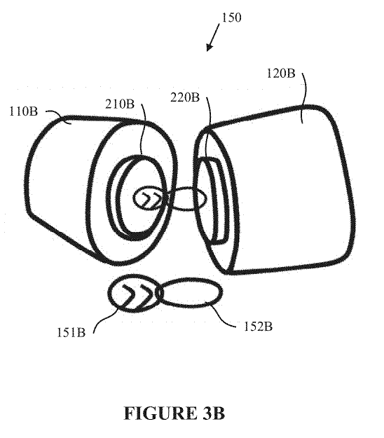

FIGS. 3A and 3B illustrate in greater detail the adjustable length linkage 150 in an exemplary fishing lure according to an embodiment of the present disclosure. Adjustable length linkage 150 comprises two interlocking loops: loop 151 and loop 152. In FIG. 3A, loop 151A and 152A are shown in an enlarged view in the foreground of FIG. 3A for the purpose of clarity. In FIG. 3B, loop 151B and 152B are shown in an enlarged view in the foreground of FIG. 3B for the purpose of clarity.

In FIG. 3A, selected portions of body segment 110A and tail segment 120A are shown. Magnet 210A is attached to body segment 110A and loop 151A is attached to the surface of magnet 210A. Magnet 220A is attached to tail segment 120A and loop 152A is attached to the surface of magnet 220A. In FIG. 3B, selected portions of body segment 110B and tail segment 120B are shown. Magnet 210B is attached to body segment 110B and loop 151B is attached to the surface of magnet 210B. Magnet 220B is attached to tail segment 120B and loop 152B is attached to the surface of magnet 220B.

Loop 151 comprises two internal hooks within the circumference of loop 151. A user may adjust the length of linkage 150 by manually engaging loop 152 around one of the two internal hooks or by not engaging either internal hook. In FIG. 3B, loop 152B is not engaged around either internal hook of loop 151B and linkage 150 is at its greatest length. In FIG. 3A, loop 152A is engaged around the right internal hook of loop 151A so that linkage 150 is slightly shortened. Triage 150 could be made even shorter by engaging loop 152A around the left internal hook of loop 151A. By adjusting the length of linkage 150, the repulsive forces of magnets 210 and 220 may be increased and decreased. The shorter linkage 150 is, the stronger the force of repulsion is.

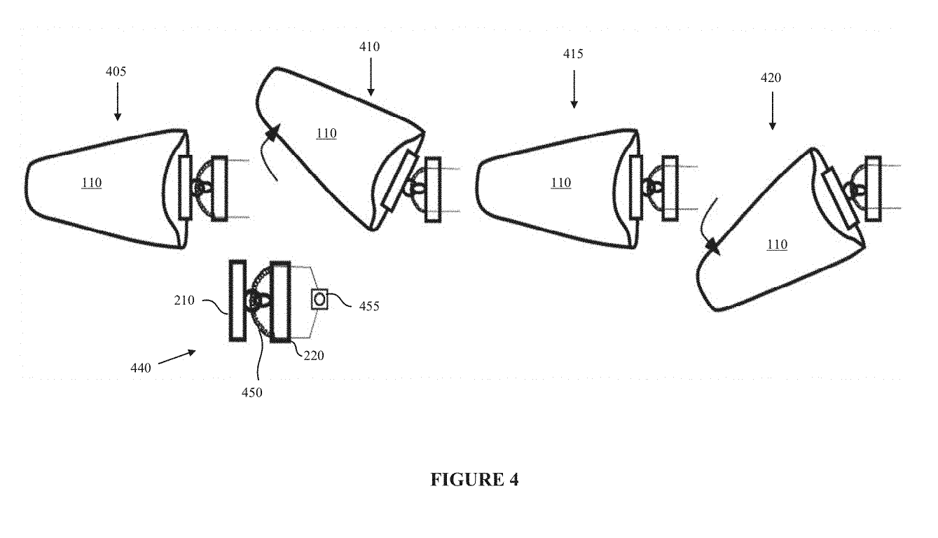

FIG. 4 illustrates articulated motion used to generate electrical energy in an exemplary fishing lure according to an embodiment of the present disclosure. In FIG. 4, body segment 110, magnets 210 and 220, and linkage 150 are all shown. Reference 440 illustrates generally an enlarged view of magnets 210 and 220, conductive coil 450, and circuit 455. For clarity, tail segment 120 is not shown. However, it will be appreciated that the lateral movements of body segment 110 are shown with respect to tail segment.

Referring back to FIG. 2, body segment 110 may move horizontally (i.e., left-right) or vertically (i.e., up-down), or a combination of horizontally and vertically, with respect to tail segment 120. This is because only a single linkage 150 is used and body segment 110 and tail segment 120 can swivel freely around linkage 150 in both dimensions. However, if two vertically aligned linkages are used to couple body segment 110 and tail segment 120, then vertical movement may be limited and only horizontal articulation may occur. Similarly, if two horizontally aligned linkages are used to couple body segment 110 and tail segment 120, then horizontal movement may be limited and only vertical articulation may occur.

In FIG. 4, it is assumed that body segment 110 is viewed from above and that horizontal (left-right) articulation is depicted. Reference 405 illustrates body segment 110 aligned with tail segment 120. As lure 100 is dragged through the water, mechanical forces from the water or the bottom causes displacement at the point of articulation. Reference 410 illustrates body segment 110 deflected to one side (e.g., the right) about 30 degrees with respect to tail segment 120. Reference 415 illustrates body segment 110 returned to an aligned position with respect to tail segment 120. Reference 420 illustrates body segment 110 deflected to one side (e.g., the left) about 30 degrees with respect to tail segment 120.

The horizontal motion of body segment 110 and tail segment 120 comprises mechanical energy that may be converted to electrical energy by conductive coil 450 and circuit 455. The fluctuating magnetic field caused by the movements of magnets 210 and 220 may induce an oscillating current in coil 450 that may be converted to, for example, a DC voltage by a rectifying circuit in circuit 455. The captured electrical energy may be used, for example, to illuminate an LED or for another purpose.

It is not necessary for linkage 150 to be attached between magnets 210 and 220 as shown. In other embodiments, linkage 150 may be coupled directly to body segment 110 and tail segment 120 and proximate magnets 210 and 220. In one embodiment, a pair of linkages may be coupled directly to body segment 110 and tail segment 120 and magnets 210 and 220 may be disposed in between the pair of linkages 150.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A fishing lure comprising:
a body segment;
a secondary segment;
a linkage for coupling the body segment and the secondary segment;
a first magnet coupled to the body segment; and
a second magnet coupled to the secondary segment,
wherein the first and second magnets are set up in a state of repulsion in order to move the body segment and secondary segment apart.

2. The fishing lure as set forth in claim 1 wherein the linkage is adjustable in length in order to increase or decrease the force of repulsion between the first and second magnets.

3. The fishing lure as set forth in claim 1 wherein the linkage is coupled between the first and second magnets.

4. The fishing lure as set forth in claim 3 wherein the linkage comprises a first portion attached to a face of the first magnet and a second portion that is interlocked with the first portion and is attached to a face of the second magnet.

5. The fishing lure as set forth in claim 4 wherein the first portion comprises a first loop and the second portion comprises a second loop interlocked with the first loop.

6. The fishing lure as set forth in claim 5 wherein the linkage is adjustable in length to thereby increase or decrease the force of repulsion between the first and second magnets.
